(19) United States
(12) Patent Application Publication
(10) Pub. No.: US 2026/0138003 A1
(43) Pub. Date: May 21, 2026

(54) CONTEXTUAL AI PLAYER INTENT WITH ENVIRONMENT FOR COMPUTER GAMEPLAY

(71) Applicant: Sony Interactive Entertainment Inc., Tokyo (JP)

(72) Inventor: Xiaoyong Ye, San Mateo, CA (US)

(21) Appl. No.: 18/954,082

(22) Filed: Nov. 20, 2024

(51) Int. Cl. A63F 13/213; G06F 3/01; G06T 19/00

(52) U.S. Cl. CPC A63F 13/213; G06F 3/013; G06T 19/006

(57) ABSTRACT

In one aspect, particular regions of image frames from an image sensor are processed at different rates. Regions associated with user gaze and other user interaction with the environment during gameplay may be processed at faster rates than other regions which might not change much during gameplay or impact the gameplay itself. This in turn helps minimize processing constraints while still providing high-fidelity location tracking and extended reality (XR) object rendering for gameplay.

### FIELD

The disclosure below relates to technically inventive, non-routine solutions that are necessarily rooted in computer technology and that produce concrete technical improvements. In particular, the disclosure below relates to contextual artificial intelligence (AI) player intent with the environment for computer gameplay.

### BACKGROUND

Modern augmented reality (AR) headsets often include a plethora of sensors to monitor the world around the user. However, the present disclosure recognizes that it has gotten to the point where there are so many sensors on the headset that all of their inputs cannot be effectively processed by the headset hardware itself. Or, even if the inputs can be sub-optimally processed, this still consumes an undue amount of processor resources and power. There are currently no adequate solutions to the foregoing computer-related, technological problems.

### SUMMARY

Accordingly, in one aspect an apparatus includes at least one processor system configured to receive image frames from an image sensor and to identify, from the image frames, an area of user interest. The at least one processor system is also configured to process, at a first rate, a first region of the image frames. The first region shows the area of user interest, and the first rate is faster than a second rate at which a second region of the image frames is processed. The at least one processor system is also configured to use the processing of the first region at the first rate to render, as part of a computer game, an extended reality (XR) object as being located at the area of interest.

In some example implementations, the at least one processor system may be configured to access a database to identify that the first region shows the area of user interest, with the database indicating different potential items of user interest. In one specific implementation, the at least one processor system may be configured to identify the first region based on accessing the database and based on user gaze location. Furthermore, if desired the image frames may be first image frames, and here the at least one processor system may be configured to configure the database with the different potential items of user interest based on second image frames from the image sensor. The second image frames may therefore be different from the first image frames, with the second image frames being received from the image sensor prior to receipt of the first image frames.

Also in various example embodiments, the at least one processor system may be configured to identify the area of user interest based on a determination that user gaze location corresponds to the area of user interest. Additionally or alternatively, the at least one processor system may be configured to identify the area of user interest based on a determination that user hand location corresponds to the area of user interest. Also if desired, the at least one processor system may be configured to identify the area of user interest based on a determination that user speech corresponds to the area of user interest.

What's more, in some specific non-limiting instances, the apparatus may include a headset, and the headset may include the image sensor and a transparent display. Here, the at least one processor system may be configured to render, on the transparent display, the XR object as part of the computer game.

Also in some non-limiting instances, processing the first region at the first rate may include executing feature extraction at a first frame rate using the image frames from the image sensor.

In addition, in some cases the at least one processor system may be configured to process the second region at the second rate, and even to process a third region of the image frames at a third rate. The third rate may be slower than the first rate but faster than the second rate. The at least one processor system may even be configured to process the third region at the third rate based on one or more factors, such as previous user interaction with an object shown in the third region and/or the object being indicated in a database as an interactive object for gameplay. In one specific instance where the one or more factors include the previous user interaction with the object shown in the third region, the previous user interaction may include the user previously looking at the object and/or the user previously touching the object.

In another aspect, a method includes receiving image frames from an image sensor on a headset and identifying, from the image frames, an area of user interest. The method also includes processing, at a first rate, a first region of the image frames. The first region shows the area of user interest. The method also includes, concurrent with processing the first region at the first rate, processing a second region of the image frames at a second rate that is slower than the first rate. The method then includes using the processing of the first region at the first rate to render a computer-generated object as appearing in three-dimensional (3D) space in relation to the area of user interest.

In some cases, the method may also include using the processing of the second region at the second rate to monitor the real-world environment of a user while the user plays a computer game. Also if desired, the computer-generated object may include an object being rendered as part of the computer game.

In still another aspect, an apparatus includes at least one computer readable storage medium (CRSM) that is not a transitory signal. The at least one CRSM includes instructions executable by a processor system to receive image frames from an image sensor and to identify, from the image frames, an area of user interest. The instructions are also executable to, based on the identification of the area of user interest, process a first region of the image frames at a first rate. The first region shows the area of user interest. The instructions are also executable to use the processing of the first region at the first rate to render a virtual object in relation to the area of user interest.

In some non-limiting embodiments, the instructions may also be executable to, concurrent with processing the first region at the first rate, process a second region of the image frames at a second rate to monitor the real-world environment of a user. The second rate may be slower than the first rate.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 shows an example image frame with different regions processed at different rates being highlighted;

FIG. 3 shows example logic in example flow chart format that may be executed by an apparatus consistent with present principles; and

FIG. 4 shows an example graphical user interface (GUI) that may be presented on a display to configure one or more settings of an apparatus to operate consistent with present principles.

### DETAILED DESCRIPTION

The detailed description below provides technical systems and methods for contextual AI player intent in relation to the user's environment during gameplay. Thus, based on player gaze, hand motion, and speech, artificial intelligence (AI) models may be used to determine user focus, which may then be used to compress sensor data for computation for always-on contextual AI with a lower computation burden. Thus, the AI system may only, or primarily, focus on dynamic objects that interact with the player. In some particular instances, both static and dynamic portions of the scene may be encoded prior to gameplay to further reduce latency.

With the foregoing in mind, it is to be understood that this disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

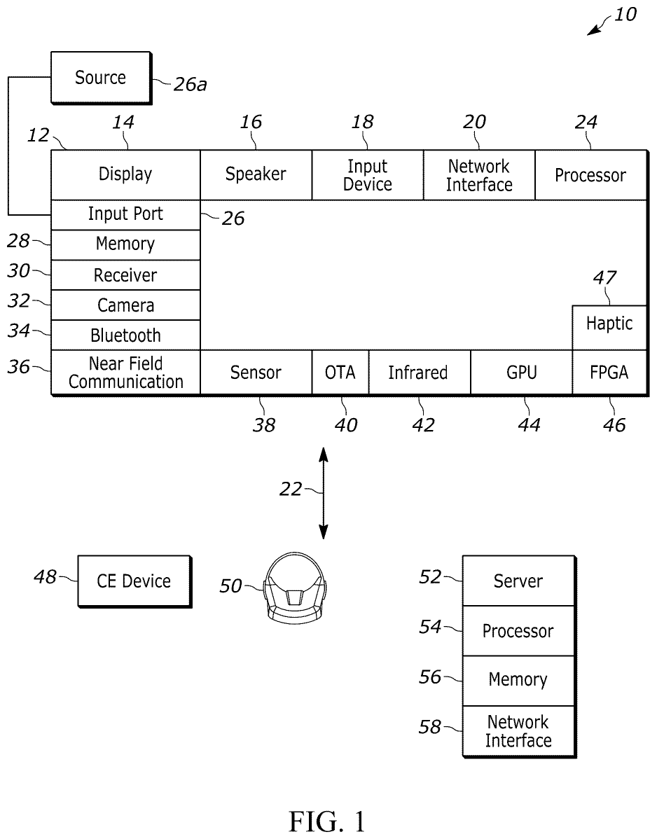

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12 consistent with present principles. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer/video game audio and video to the AVD 12 via commands sent directly to the AVD 12 and/or through the below-described server, while a second CE device 50 may include similar components as the first CE device 48. The CE device 48 might additionally or alternatively be configured as a computer game controller manipulated by a player, or another CE device may be established as such.

Also in the example shown, the second CE device 50 may be a head-mounted display (HMD) worn by a player. The HMD may include a heads-up transparent or non-transparent display for respectively presenting AR content, mixed reality (MR) content, and/or virtual reality (VR) content (more generally, extended reality (XR) content). The HMD may be configured as a glasses-type display (e.g., smart glasses) or as a head-circumscribing AR or VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components discussed in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

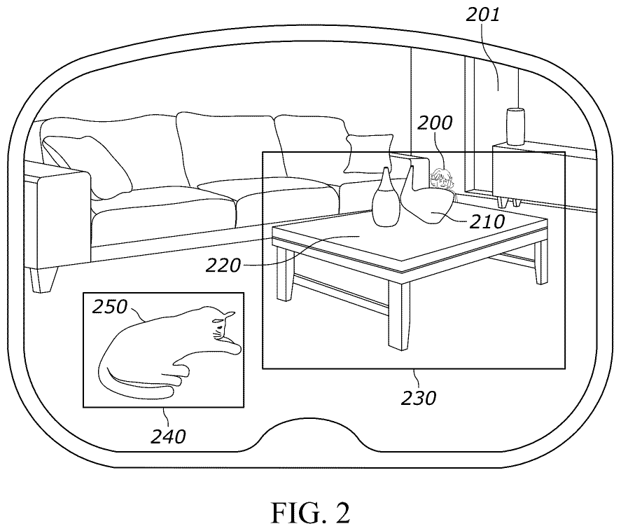

Now in reference to FIG. 2, an example image frame 201 is shown. The image frame 201 has the same general perspective as the user's own first-person view of the user's environment as seen through the transparent display of the user's headset. In the present example, the environment is the user's living room.

The headset itself may be established by smart glasses, an XR headset, or another type of headset. But regardless of headset type, it is to be understood that a camera on the headset generates the image frame 201 and therefore has an outward-facing field of view that is similar to the user's own field of view of the environment through the transparent display of the headset (save for the camera field of view potentially being wider and taller than the user's own naked-eye field of view).

Now suppose the user is playing a computer game using the headset, with the transparent display of the headset presenting one or more computer-generated, interactive virtual objects for gameplay. For example, the objects may include one or more 3D XR objects that appear to be located in the real-world. The XR objects may therefore be presented in spatial relationship to real-world objects according to the user's perspective through the headset display. Accordingly, in the present example an XR graphical object 200 is presented in the form of a miniature person that is virtually hiding behind a real-world vase 210 sitting on a real-world coffee table 220. It is to be further understood that the game in this instance involves the user visually locating the object 200 and verbally indicating its location to progress in the game (as detected using speech recognition software being executed as part of the game).

With this scenario in mind, it is to be understood that the headset may execute high-fidelity camera-based location tracking to continue to render the object 200 as though appearing in real-world 3D space at a particular location in relation to the real-world vase 210 notwithstanding any movement of the user/headset or even movement of the real-world objects 210, 220 themselves. To do so, the headset may process images from the headset's camera at a high frame rate to monitor for such movements around the real-world location at which the object 200 is virtually placed to adjust object rendering without undue latency, creating an XR experience that is as realistic as possible. Note that computer vision and other AI-based image processing techniques may be used for location tracking, including simultaneous localization and mapping (SLAM) to track motion of the headset itself.

However, absent present principles, this type of high-fidelity image processing would be difficult for the headset due to the relatively large field of view of the headset's camera, entire images of which would have to be processed at the high frame rate. Specifically, the headset might be overburdened with too much data to effectively process the data within the time period that would be desired for high-fidelity image rendering. Even if the headset had a relatively high-powered processor that could do so, the image processing could take up undue processor resources and consume large amounts of the headset's battery power.

Accordingly, consistent with present principles, the headset may process only certain regions of the image frames from the camera at the higher frame rate, and concurrently process other regions of the same image frames at incrementally lower frame rates depending on those other regions'level of priority. As such, a box is shown in FIG. 2 to demonstrate a region 230 sampled at the highest frame rate.

Note that the region 230 includes image portions showing the vase 210 and coffee table 220 being used by the system for gameplay, but also additional real area around the vase 210 and coffee table 220. The additional area may form part of the first region 230 based on the recognition that the user's perspective might change (due to head movements), or one or more real-world objects within the region 230 might move themselves, yet still be involved in image rendering. Therefore, an X-Y region larger than just the image region showing the relevant real-world objects themselves may be monitored at the highest frame rate to account for any such movement to still render the object 200 spatially in XR with low latency. In certain non-limiting examples, the region 230 may therefore encompass the actual bounds of the relevant real-world objects 210, 220, plus a threshold distance around those objects (e.g., six real-world inches) in the X and Y dimensions. The threshold therefore allows for the accounting of movements during gameplay to still render the object 200 with high-fidelity, while also still minimizing processor burden and power consumption.

In terms of the aforementioned incrementally lower frame rates, other regions of the image frames may be processed at different rates depending on their assigned level of priority. For example, a region 240 may be processed at a frame rate slower than for the region 230, but still faster than a rate used for other regions of the same image frames received from the camera. In the present example, this may be due to the region 240 including the user's cat 250 and due to the user previously looking at or touching the cat 250 during gameplay, hence the game previously hiding XR objects around the cat 250 and potentially hiding XR objects around the cat 250 again in the future when the user looks back at the cat 250 again. With this in mind, present principles recognize that it may be advantageous to monitor the region 240 at a slower frame rate than the region 230 so that the headset can dedicate its resources primarily to monitoring the region 230, while still concurrently monitoring the region 250 at a slower frame rate that nonetheless allows for adequate secondary AI tracking of the cat 250. Therefore, the rate at which the first region 230 of the images frames is processed may be sixty to one hundred twenty frames per second (fps) in non-limiting examples, while the rate at which the second region 240 of the image frames is processed may be twenty four to thirty fps.

Other regions of the image frames besides the regions 230, 240 may be processed at an even slower rate. This may be done based on those portions of the image frames showing static content not involved in gameplay. As such, the other regions may be processed at one frame per second, or might not even be processed at all in some examples. However, one frame per second may be advantageous in certain examples so that the headset can still monitor the user's environment for safety, to update the state of the environment as part of the XR experience, and/or for other reasons. As one particular example, the static environment may be monitored so that if another animal or object like a robot entered the room unexpectedly and the user might otherwise trip over that object, a notification can be provided at the headset to avoid the collision.

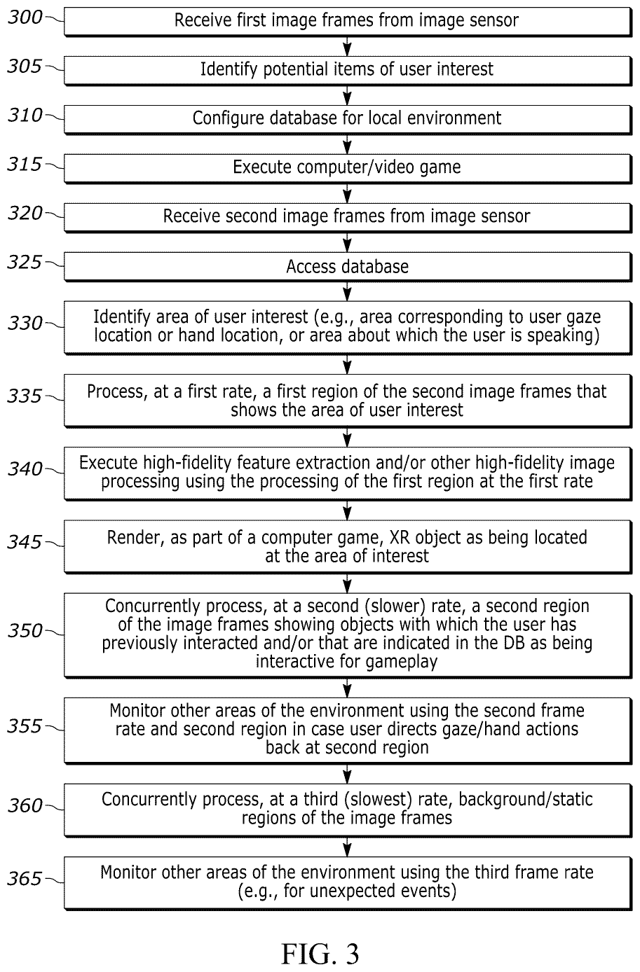

Continuing the detailed description in reference to FIG. 3, this figure shows example logic that may be executed by an apparatus such as a client device (headset or smartphone) and/or coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Note that while the logic of FIG. 3 is shown in flow chart format, other suitable logic may also be used.

Beginning at block 300, the apparatus may receive first images from an image sensor, such as a red green blue (RGB) camera, infrared (IR) camera, photo diode, light detection and ranging (LIDAR) system, etc. on a headset. The logic may then proceed to block 305 where, prior to gameplay beginning, the apparatus may identify potential items of user interest from the first image frames. SLAM may be used to locate the user and map the room, while other AI-based 3D object detection/tracking algorithms may be used to locate objects in the environment as well using a camera/depth sensor on the headset. The apparatus may then build a clear relation of the objects and user and the room.

The potential items of user interest may be identified as such based on those objects being identified as dynamically movable objects (e.g., animals and other animate objects), and/or based on those objects being identified as objects usable for whatever XR game the user has selected for gameplay. As such, those potential items of user interest may be predefined by the game or apparatus for recognition so that, at block 310 when they are in fact recognized from a given environment, an environment-specific game object database that indexes those objects and their geospatial locations may be created (or otherwise configured) to indicate the objects by object ID and location.

The database may also include other real-world objects (and corresponding locations) that are recognized from the environment as static objects that are not likely to move and/or will not be used as part of the game.

Thus, as the image sensor's perspective of the environment changes due to movements of the headset and/or movements of objects themselves within the environment, the database may be referenced during gameplay to quickly decipher whether certain objects (and hence corresponding image frame regions) should now be monitored at higher frame rates given the new perspective or movement.

After environment preprocessing is executed consistent with the description above, the logic may then proceed to block 315 where the computer/video game itself is executed to render XR objects as part of a gameplay instance. The logic may then proceed to block 320 where second image frames may be received from the image sensor during gameplay. Then at block 325 the aforementioned database may be accessed during game execution to, at block 330, execute object recognition to identify one or more first regions of the image frames that show respective areas of user interest as indicated in the database.

Also at block 330, particular areas of user interest may be identified apart from the database based on those areas corresponding to a current gaze location of the user as determined through eye tracking (e.g., executed at the headset using images from another image sensor that images the user's eyes). For example, the areas may be real-world areas at which a real-world object is located that the user is identified as looking at.

The areas of user interest may additionally or alternatively be areas corresponding to current locations of the user's hands, and/or objects held by the hand(s) during gameplay (where those objects might also be used for the gameplay itself). Still further, the areas of user interest may be areas within the environment about which the user is identified as speaking. The user's speech may therefore be detected by a microphone on the headset, processed using speech recognition software and/or other AI-based audio processing techniques, and then correlated to objects shown in the image frames themselves as identified via image-based object ID.

However, further note that the database of candidate items of interest (and their corresponding locations within the environment as determined using SLAM and other techniques) may still be used along with the techniques above to identify a particular area of user interest. This may help cut down on false positives where there might be a device ambiguity as to which object is being gazed at, touched, or verbally referenced.

From block 330 the logic may then proceed to block 335. At block 335 the apparatus may process, at a first (fastest) rate, the first region(s) of the second image frames that show the respective area(s) of user interest. This may be done to, at block 340, execute high-fidelity feature extraction and/or other AI-based image processing of the first region(s). This in turn may be used to render, at block 345 as part of the computer game, one or more XR objects in high-fidelity so that those XR objects appear to be located at their respective real-world 3D areas of interest.

Additionally, at block 350 concurrent with the processing of the first region(s) at the first rate, the apparatus may also process a second region(s) of the image frames at a second (slower) rate based on one or more factors. For example, the second region(s) may show objects with which the user has previously interacted during the same gameplay instance, and/or objects that are indicated in the database as being interactive for gameplay consistent with the description above. The apparatus may do so to, at block 355, monitor those other areas of the user's environment in case the user again directs his/her gaze, hand actions, and/or speech back to those real-world objects during gameplay so that XR objects may then be presented in relation to those real-world objects with minimal latency.

What's more, at block 360 concurrent with the processing of the first region(s) at the first rate and the processing of the second region(s) at the second rate, the apparatus may also process background and/or static regions of the second image frames at a third (even slower rate). This may be done to, at block 365, monitor those other areas of the environment using the third frame rate to still detect any unexpected events as set forth above.

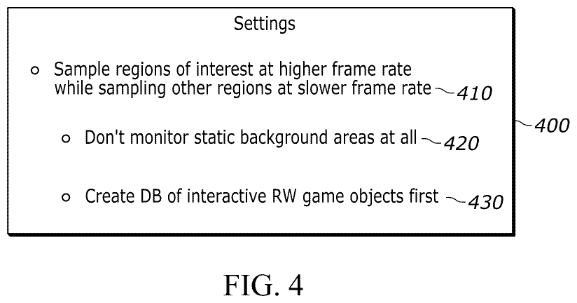

Continuing the detailed description in reference to FIG. 4, this figure shows an example settings graphical user interface (GUI) 400 that may be presented to configure one or more settings of an apparatus to undertake present principles. The settings GUI 400 may be presented on the display of an XR headset or connected client device, such as a smartphone.

As shown in FIG. 4, the GUI 400 may include a first option 410 that may be selected a single time to set or configure the apparatus to, for multiple future game instances, sample regions of user interest at higher frame rates while sampling other image frame regions at slower frame rates consistent with the disclosure above. Thus, even if the relevant device had the ability to process voluminous amounts of image data, the user may select the option 410 to still save power and minimize processing constraints. However, there may be instances where the user might not want to do so, such as where the user is not in a private residence but instead at a public place where the user wants the headset to monitor the entire world around them for safety, and so the user might also elect in certain circumstances to have the headset track the entire environment at the high-fidelity frame rate so the user can be notified of potential safety threats around the user. Thus, it is to be noted here that the image sensor that is used may be one with a relatively large field of view, such as a one hundred eighty degree or three hundred sixty degree camera.

But also recognizing that optimizing power savings and minimizing processing constraints may be further enhanced in safe environments like the user's personal residence, the user might also select sub-option 420 after selecting option 410. The sub-option 420 may be selected a single time to set or configure the device to, for multiple future game instances, decline to monitor static background frame regions at all (e.g., not at any frame rate, even one fps).

Additionally, recognizing that present principles may be implemented without first configuring an environment-specific database in advance of gameplay as set forth above, in some instances the user may select the option 430 to set or configure the apparatus to do so when desired by the user to further reduce latency in game execution.

Moving on from FIG. 4, it is to also be understood that present principles may apply to processing data from other types of sensors as well, and to image rendering in technological environments besides computer/video games specifically. This includes applying present principles to other types of XR experiences. Additionally, other types of client devices besides headsets may be used consistent with present principles, including smartphones and other mobile devices with XR capabilities.

Present principles may also use sound cues in the environment to then process a corresponding image frame region in video showing the source of the sound itself. Thus, the system may detect specific sound patterns in the user's environment (e.g., a loud noise, music, or people talking) and adjust processing based on that, focusing on those sources of sound as appearing in the image frames themselves.

Present principles may also extend to collaborative design and/or social VR experiences, where the system may dynamically adjust based on multi-person group focus/eye gaze as well as collaborative activities like pointing at an object, sharing gaze, etc. Thus, concurrent user input from two different users may indicate an item in the environment for which region-based fast frame rate processing should transpire.

What's more, in some instances the system may dynamically switch processing between cloud and client-side devices based on network performance, using low-latency predictions of user actions to minimize lag. The system can then decide in real-time when to offload tasks to the cloud based on contextual data from the user and environment (e.g., offload to server when there are multiple frame regions that are areas of user interest).

Providing an example, in a mixed-reality cooking game, the system could recognize real kitchen objects and overlay virtual tasks based on both the player's gaze and interaction with those objects. In other examples, the system could also overlay interactive tutorials on real-world tools or instruments (like lab equipment or musical instruments) by detecting what the user is physically handling and processing those image regions. The AI models can therefore compress streamed XR scenes by selectively lowering the frame rate or detail of processing in “non-critical” areas, reducing bandwidth consumption while ensuring a seamless high-fidelity experience in regions of interest.

While the particular embodiments are herein shown and described in detail, it is to be understood that the subject matter which is encompassed by the present application is limited only by the claims.

What is claimed is:

1. An apparatus, comprising:
at least one processor system configured to:
receive image frames from an image sensor;
identify, from the image frames, an area of user interest;
process, at a first rate, a first region of the image frames, the first region showing the area of user interest, the first rate being faster than a second rate at which a second region of the image frames is processed; and
use the processing of the first region at the first rate to render, as part of a computer game, an extended reality (XR) object as being located at the area of interest.

2. The apparatus of claim 1, wherein the at least one processor system is configured to:
access a database to identify that the first region shows the area of user interest, the database indicating different potential items of user interest.

3. The apparatus of claim 2, wherein the at least one processor system is configured to:
identify the first region based on accessing the database and based on user gaze location.

4. The apparatus of claim 2, wherein the image frames are first image frames, and wherein the at least one processor system is configured to:
based on second image frames from the image sensor, configure the database with the different potential items of user interest.

5. The apparatus of claim 4, wherein the second image frames are different from the first image frames, and wherein the second image frames are received from the image sensor prior to receipt of the first image frames.

6. The apparatus of claim 1, wherein the at least one processor system is configured to:
identify the area of user interest based on a determination that user gaze location corresponds to the area of user interest.

7. The apparatus of claim 1, wherein the at least one processor system is configured to:
identify the area of user interest based on a determination that user hand location corresponds to the area of user interest.

8. The apparatus of claim 1, wherein the at least one processor system is configured to:
identify the area of user interest based on a determination that user speech corresponds to the area of user interest.

9. The apparatus of claim 1, comprising a headset, wherein the headset comprises the image sensor and a transparent display, and wherein the at least one processor system is configured to:
render, on the transparent display, the XR object as part of the computer game.

10. The apparatus of claim 1, wherein processing the first region at the first rate comprises executing feature extraction at a first frame rate using the image frames from the image sensor.

11. The apparatus of claim 1, wherein the at least one processor system is configured to:
process the second region at the second rate.

12. The apparatus of claim 11, wherein the at least one processor system is configured to:
process a third region of the image frames at a third rate, the third rate being slower than the first rate but faster than the second rate.

13. The apparatus of claim 12, wherein the at least one processor system is configured to:
process the third region at the third rate based on one or more factors.

14. The apparatus of claim 13, wherein the one or more factors comprise one or more of: previous user interaction with an object shown in the third region, the object being indicated in a database as an interactive object for gameplay.

15. The apparatus of claim 14, wherein the one or more factors comprise the previous user interaction with the object shown in the third region, and wherein the previous user interaction comprises one or more of: the user previously looking at the object, the user previously touching the object.

16. A method, comprising:
receiving image frames from an image sensor on a headset;
identifying, from the image frames, an area of user interest;
processing, at a first rate, a first region of the image frames, the first region showing the area of user interest;
concurrent with processing the first region at the first rate, processing a second region of the image frames at a second rate that is slower than the first rate; and
using the processing of the first region at the first rate to render a computer-generated object as appearing in three-dimensional (3D) space in relation to the area of user interest.

17. The method of claim 16, comprising:
using the processing of the second region at the second rate to monitor the real-world environment of a user while the user plays a computer game.

18. The method of claim 16, wherein the computer-generated object comprises an object being rendered as part of a computer game.

19. An apparatus, comprising:
at least one computer readable storage medium (CRSM) that is not a transitory signal, the at least one CRSM comprising instructions executable by a processor system to:
receive image frames from an image sensor;
identify, from the image frames, an area of user interest;
based on the identification of the area of user interest, process, at a first rate, a first region of the image frames, the first region showing the area of user interest; and
use the processing of the first region at the first rate to render a virtual object in relation to the area of user interest.

20. The apparatus of claim 19, wherein the instructions are executable to:
concurrent with processing the first region at the first rate, process a second region of the image frames at a second rate to monitor the real-world environment of a user, the second rate being slower than the first rate.
